(19) United States
(12) Patent Application Publication
(10) Pub. No.: US 2019/0225048 A1
(43) Pub. Date: Jul. 25, 2019

(54) REGISTER AND METHOD OF MANUFACTURING THE SAME

(71) Applicants: KABUSHIKI KAISHA TOYOTA JIDOSHOKKI, Kariya-shi (JP); TOYOTA JIDOSHA KABUSHIKI KAISHA, Toyota-shi (JP)

(72) Inventors: Masayuki KOMATSU, Kariya-shi (JP); Hiroki TAKADA, Kariya-shi (JP); Yoshihiko YASUI, Kariya-shi (JP)

(73) Assignees: KABUSHIKI KAISHA TOYOTA JIDOSHOKKI, Kariya-shi (JP); TOYOTA JIDOSHA KABUSHIKI KAISHA, Toyota-shi (JP)

(21) Appl. No.: 16/253,452

(22) Filed: Jan. 22, 2019

(30) Foreign Application Priority Data
Jan. 24, 2018 (JP) 2018-009372

(51) Int. Cl. B60H 1/00; B60H 1/34

(52) U.S. Cl. CPC B60H 1/00671; B60H 1/00207; B60H 1/00564; B60H 2001/00721; B60H 2001/00214; B60H 2001/007; B60H 1/3414

(57) ABSTRACT

A register faces a specific seat and feeds air to the specific seat. An hypothetical reference line is defined that extends in the front-back direction of the specific seat through the center in the width direction of the specific seat. In comparison between a first bezel side wall and a second bezel side wall, the second bezel side wall is positioned closer to the reference line than the first bezel side wall. A second duct side wall is bent such that a downstream side of the second duct side wall is positioned farther in the width direction from the reference line than an upstream side of the second duct side wall.

### BACKGROUND

The disclosure relates to a register and a method of manufacturing the same.

Conventional registers are disclosed, respectively, in FIGS. 1 and 2 of Japanese Laid-Open Patent Publication No. 2006-88806 and FIGS. 5 and 6 of Japanese Laid-Open Utility Model Publication No. 3-91207. These registers are provided within a passenger compartment in which multiple seats are disposed. Each register faces a specific seat selected from the seats and feeds air to the specific seat. An imaginary reference line is defined that extends in the front-back direction of the specific seat through the center in the width direction of the specific seat.

The register in Japanese Laid-Open Patent Publication No. 2006-88806 includes an air duct, a bezel, and multiple fins. The air duct is formed in a tubular shape inside of which air flows in a flow direction from the upstream side toward the downstream side. The bezel is formed in a frame shape and connected to the air duct on the downstream side thereof to face the specific seat. The fins are each formed in a plate shape and provided in a displaceable manner within the air duct. Each fin is configured to guide air within the air duct.

In more detail, the bezel has a first bezel side wall and a second bezel side wall. The second bezel side wall is opposed to the first bezel side wall. In comparison between the first bezel side wall and the second bezel side wall, the second bezel side wall is positioned closer to the reference line than the first bezel side wall. The air duct also has a first duct side wall extending in the flow direction to be connected to the first bezel side wall and a second duct side wall extending in the flow direction to be connected to the second bezel side wall. A raised portion protruding toward the second duct side wall is formed on the downstream side of the first duct side wall. Similarly, a raised portion protruding toward the first duct side wall is formed on the downstream side of the second duct side wall. The fins are also arranged between the first duct side wall and the second duct side wall with a predetermined space between each other in the width direction of the air duct. One of the fins that is closest to the second duct side wall is defined as a specific fin.

In the register of this type, the fins are displaced to adjust the direction in which air flows out through the bezel. This allows air to be applied to a passenger on the specific seat by displacing the fins toward the passenger, that is, toward the reference line. When the fins are thus displaced, air guided by the fins other than the specific fin flows out through the bezel at an almost constant angle along the fins. In contrast, air guided by the specific fin flows along the second duct side wall while flowing between the specific fin and the second duct side wall so as to flow out through the bezel at an angle different from that of the air guided by the fins other than the specific fin. This causes the air guided by the fins other than the specific fin and the air guided by the specific fin, when flowing out through the bezel, to collide with each other, which may result in a reduction in the directionality of air.

In this respect, the register in Japanese Laid-Open Patent Publication No. 2006-88806 is configured such that when the fins are displaced so as to apply air to the passenger on the specific seat, the specific fin comes into contact with the raised portion that is formed on the second duct side wall. This prevents air from flowing between the specific fin and the second duct side wall in the register to increase the directionality of air.

In contrast, the register in Japanese Laid-Open Utility Model Publication No. 3-91207 includes a guide member. The guide member is made of rubber to be elastically deformable. The register is configured such that the guide member can cause air to flow toward the fins while changing the direction of air flowing through the air duct to increase the directionality of air.

### SUMMARY

However, in the register described in Japanese Laid-Open Patent Publication No. 2006-88806, the raised portion is visible from the passenger compartment, so that the register becomes less aesthetic in appearance.

Therefore, if the bezel is designed such that the raised portion is not visible from the passenger compartment, the flexibility of bezel design is reduced accordingly.

Also, the register in Japanese Laid-Open Utility Model Publication No. 3-91207 does not necessarily have increased air directionality depending on the deformation of the guide member because the direction of air flow is determined by the guide member.

It is hence an objective of the disclosure to provide a register that exhibits a high aesthetic appearance and is capable of stably increasing air directionality, and a method of manufacturing such a register.

In accordance with one aspect of the present disclosure, a register is provided that is configured to be provided within a passenger compartment in which a plurality of seats are disposed. The register faces a specific seat selected from the seats and is configured to feed air to the specific seat. An imaginary reference line is defined that extends in a front-back direction of the specific seat through a center in a width direction of the specific seat. The register includes a tubular air duct having rigidity and configured such that air flows inside in a flow direction from an upstream side toward a downstream side, a bezel formed in a frame shape and connected to the air duct on the downstream side of the air duct to face the specific seat, and a plurality of fins each formed in a plate shape and provided in a displaceable manner within the air duct. The fins are configured so as to guide air within the air duct thereby adjusting a direction in which the air flows out through the bezel. The bezel has a first bezel side wall and a second bezel side wall opposed to the first bezel side wall. In comparison between the first bezel side wall and the second bezel side wall, the second bezel side wall is positioned closer to the reference line than the first bezel side wall. The air duct has a first duct side wall extending in the flow direction to be connected to the first bezel side wall and a second duct side wall extending in the flow direction to be connected to the second bezel side wall. The fins are configured between the first duct side wall and the second duct side wall with a predetermined space between each other in the width direction. The second duct side wall is bent such that a downstream side of the second duct side wall is positioned farther in the width direction from the reference line than an upstream side of the second duct side wall.

In the thus configured register, the second duct side wall causes air flowing through the air duct to flow away from the reference line in the width direction toward the downstream side. Accordingly, when the fins are displaced to apply air flowing out through the bezel to the passenger on the specific seat, it is possible to reduce the flow rate of air contacting one the fins that is closest to the second duct side wall, that is, air guided by the fin closest to the second bezel side wall. It is thus possible to reduce the flow rate of air flowing between the fin closest to the second bezel side wall and the second duct side wall. This allows the register to have increased directionality of air flowing out through the bezel. As a result, the register can appropriately apply air to the passenger on the specific seat.

The register is not required to have a raised portion or the like formed on the second duct side wall to increase the directionality of air. This allows the register to have an increased flexibility of bezel design.

Further, in the register, the air duct has rigidity, making it less likely to be elastically deformed. Hence, in the register, air can flow stably toward the fins due to the shape of the second duct side wall.

The register provided according to an aspect of the disclosure therefore exhibits a high aesthetic appearance and is capable of stably increasing air directionality.

The first duct side wall may extend parallel with the second duct side wall. In this case, the air duct is less likely to have a complex shape and thereby can be formed easily. Also, the first duct side wall and the second duct side wall cause air flowing through the air duct to preferably flow away from the reference line in the width direction toward the downstream side.

The fins may each have an upstream end portion positioned on the upstream side and a downstream end portion positioned on the downstream side. An imaginary extension line may be defined to extend through the second duct side wall. One of the fins that is closest to the second duct side wall may be defined as a specific fin. When the fins may be displaced such that the downstream end portions are closest to the second duct side wall, the upstream end portion of the specific fin is positioned on the extension line.

In this case, it is possible to reduce the flow rate of air guided by the specific fin, thereby reducing the flow rate of air flowing between the specific fin and the second duct side wall.

The fins may have a same shape. In this case, the register can be manufactured easily at reduced manufacturing costs.

In accordance with another aspect of the present disclosure, a method of manufacturing a register is provided. The register is provided within a passenger compartment in which a plurality of seats are disposed. The register faces a specific seat selected from the seats and being configured to feed air to the specific seat. An imaginary reference line is defined that extends in a front-back direction of the specific seat through a center in a width direction of the specific seat. The manufacturing method includes: preparing a tubular air duct having rigidity inside of which air flows in a flow direction from an upstream side toward a downstream side; connecting a bezel formed in a frame shape to the air duct on the downstream side of the air duct to face the specific seat; providing a plurality of fins each formed in a plate shape within the air duct in a displaceable manner, the fins being provided within the air duct such that the fins guide air within the air duct to adjust a direction in which the air flows out through the bezel; in comparison between a first bezel side wall of the bezel and a second bezel side wall opposed to the first bezel side wall, arranging the second bezel side wall closer to the reference line than the first bezel side wall; extending a first duct side wall of the air duct in the flow direction to be connected to the first bezel side wall; extending a second duct side wall of the air duct in the flow direction to be connected to the second bezel side wall; arranging the fins between the first duct side wall and the second duct side wall so as to be provided with a predetermined space between each other in the width direction; and bending the second duct side wall such that a downstream side of the second duct side wall is positioned farther in the width direction from the reference line than an upstream side of the second duct side wall.

The register according to an aspect of the disclosure exhibits a high aesthetic appearance and is capable of stably increasing air directionality.

Other aspects and advantages of the present disclosure will become apparent from the following description, taken in conjunction with the accompanying drawings, illustrating exemplary embodiments.

### BRIEF DESCRIPTION OF THE DRAWINGS

The disclosure may be understood by reference to the following description together with the accompanying drawings:

FIG. 1 is a schematic view showing the positional relationship between a seat and a register according to a specific embodiment of the disclosure;

FIG. 2 is an enlarged cross-sectional view taken along the line A-A in FIG. 1, showing the register according to the embodiment of FIG. 1;

FIG. 3 is a substantial part enlarged cross-sectional view of the register according to the embodiment of FIG. 1; and

FIG. 4 is an enlarged cross-sectional view similar to FIG. 2, showing a register according to a comparative example.

### DETAILED DESCRIPTION

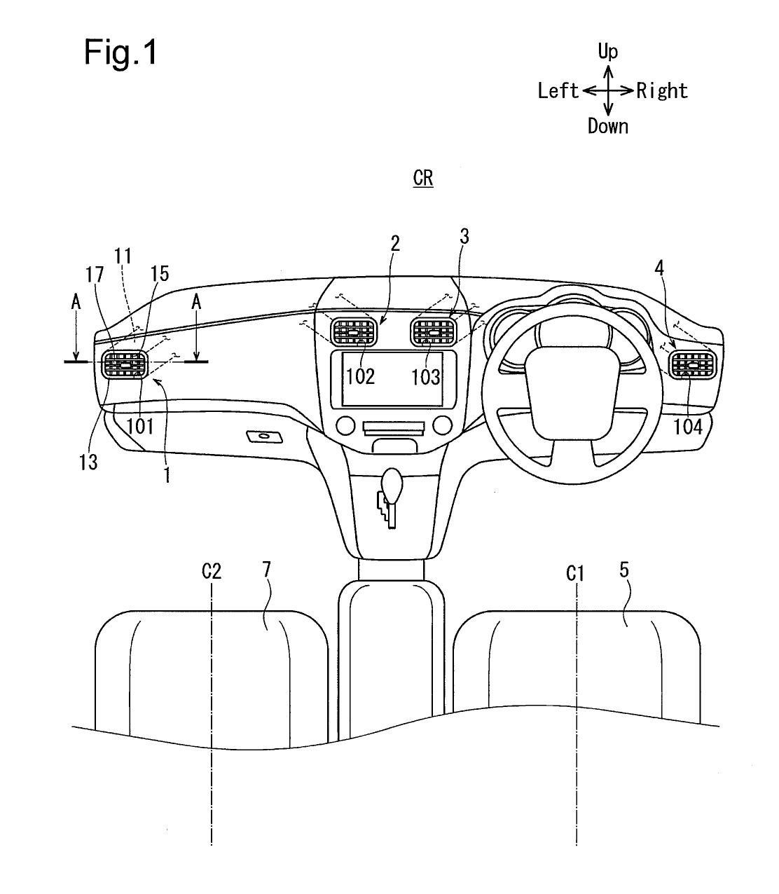

First to fourth registers 1 to 4 according to an embodiment of the present disclosure will now be described with reference to FIGS. 1 to 3.

As shown in FIG. 1, the first to fourth registers 1 to 4 according to the embodiment are employed in a vehicle. The first to fourth registers 1 to 4 may be mounted on an instrument panel 100 of the vehicle to be arranged within a passenger compartment CR.

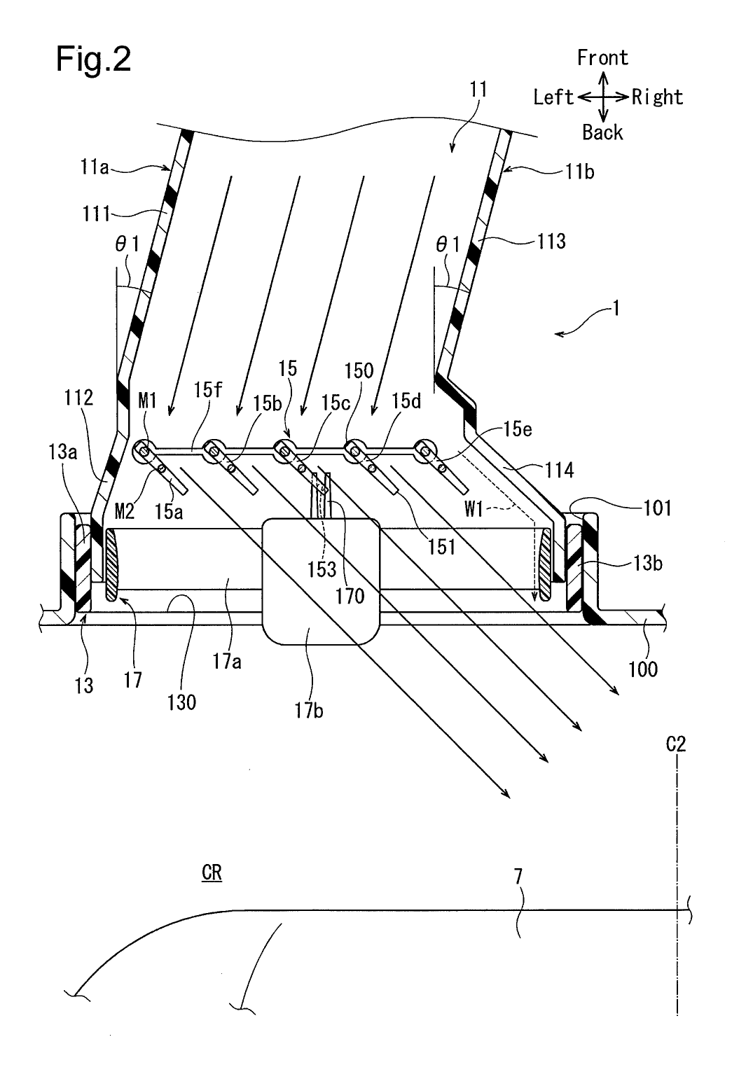

In this embodiment, the vertical direction and the lateral direction of the passenger compartment CR are defined by arrows shown in FIG. 1. In FIGS. 2 to 4, the lateral direction and the front-back direction of the passenger compartment CR are also defined in accordance with FIG. 1. These directions are merely an example for illustrative purposes.

In addition to the instrument panel 100, a first seat 5 and a second seat 7 are provided within the passenger compartment CR. The first seat 5 is arranged at the right side within the passenger compartment CR, on which the driver of the vehicle, for example, can be seated. The second seat 7 is arranged at the left side within the passenger compartment CR, on which a passenger, for example, can be seated. The vehicle may be configured in an opposite manner such that the passenger is seated on the first seat 5 and the driver is seated on the second seat 7. An imaginary reference line C1 is defined that extends in the front-back direction of the first seat 5 through the center in the width direction of the first seat 5. Similarly, an imaginary reference line C2 is defined that extends in the front-back direction of the second seat 7 through the center in the width direction of the second seat 7.

The first register 1 is configured near the left end of the instrument panel 100. The second register 2 is configured near and on the left side of the center of the instrument panel 100. The third register 3 is configured near and on the right side of the center of the instrument panel 100. The fourth register 4 is configured near the right end of the instrument panel 100. The instrument panel 100 is also provided with a first mounting portion 101 on which the first register 1 is mounted, a second portion 102 on which the second register 2 is mounted, a third mounting portion 103 on which the third register 3 is mounted, and a fourth mounting portion 104 on which the fourth register 4 is mounted.

Among the first to fourth registers 1 to 4, the first register 1 and the second register 2 face the second seat 7. In contrast, the third register 3 and the fourth register 4 face the first seat 5. That is, in this embodiment, the second seat 7 is selected as a specific seat for the first register 1 and the second register 2, while the first seat 5 is selected as a specific seat for the third register 3 and the fourth register 4. This allows the first register 1 and the second register 2 to feed air temperature-controlled through an air-conditioner (not shown) and/or air from outside the vehicle to the second seat 7. Similarly, the third register 3 and the fourth register 4 can feed air temperature-controlled through an air-conditioner and/or air from outside the vehicle toward the first seat 5.

The first register 1 and the third register 3 have the same configuration, while the second register 2 and the fourth register 4 have the same configuration. The first register 1 and the second register 2 are also formed in a laterally symmetrical manner and arranged with the reference line C2 therebetween. The third register 3 and the fourth register 4 are formed in a laterally symmetrical manner and arranged with the reference line C1 therebetween. The first and fourth registers 1, 4 may be formed to have a size different from that of the second and third registers 2, 3. The configuration and operation of this embodiment will hereinafter be described in detail based on the first register 1.

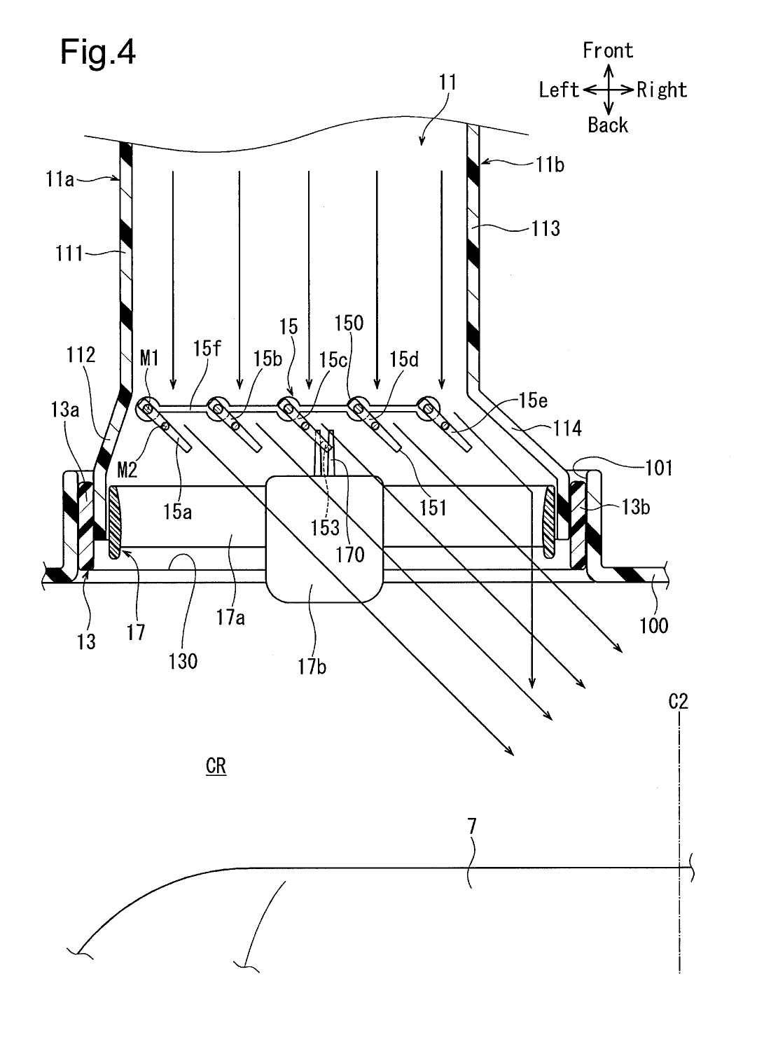

As shown in FIG. 2, the first register 1 includes an air duct 11, a bezel 13, a first fin unit 15, and a second fin unit 17. In FIG. 2, the first register 1 and the second seat 7 are shown to have an exaggerated size and positional relationship for ease in illustration. The same applies to FIG. 4.

As shown in FIG. 2, the air duct 11 is configured within the instrument panel 100. The air duct 11 is formed of hard resin. This causes the air duct 11 to have rigidity making it less likely to be elastically deformed. The air duct 11 is formed in a tubular shape with an approximately rectangular cross-section and inside of which air can flow in a flow direction from the upstream side toward the downstream side. That is, air can flow within the air duct 11 from the front side toward the back side of the passenger compartment CR. The air duct 11 may be made of metal to secure rigidity.

The air duct 11 has a first duct side wall 11a and a second duct side wall 11b. The first duct side wall 11a and the second duct side wall 11b are opposed to each other. Specifically, the first duct side wall 11a is positioned on the left side of the air duct 11, that is, at the left side within the passenger compartment CR. The second duct side wall 11b is positioned on the right side of the air duct 11. That is, the second duct side wall 11b is positioned on the right side of the passenger compartment CR relative to the first duct side wall 11a. Thus, in comparison between the first duct side wall 11a and the second duct side wall 11b, the second duct side wall 11b is positioned closer to the reference line C2 of the second seat 7 than the first duct side wall 11a. That is, of the first duct side wall 11a and the second duct side wall 11b, the first duct side wall 11a is relatively far away from the reference line C2 of the second seat 7, while the second duct side wall 11b is relatively close to the reference line C2 of the second seat 7. In other words, the distance between the second duct side wall 11b and the reference line C2 of the second seat 7 is shorter than the distance between the first duct side wall 11a and the reference line C2 of the second seat 7.

The first duct side wall 11a has a first upstream region 111 and a first downstream region 112. The second duct side wall 11b has a second upstream region 113 and a second downstream region 114. The first duct side wall 11a and the second duct side wall 11b extend in the direction of air flow.

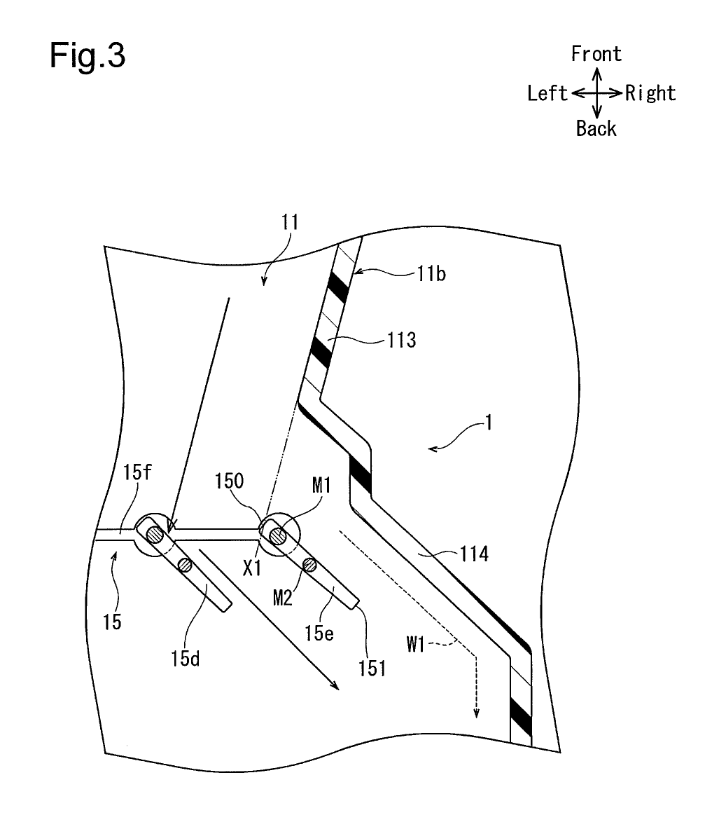

The second upstream region 113 of the second duct side wall 11b extends in a manner inclined rightward by an angle θ1 (degrees) with respect to the front-back direction of the passenger compartment CR when the second upstream region 113 is viewed forward from the rear of the passenger compartment CR. That is, the second upstream region 113 is bent such that the downstream side is positioned farther from the reference line C2 than the upstream side in the width direction of the air duct 11 (in the lateral direction in FIG. 2). As shown in FIG. 3, an imaginary extension line X1 is defined to extend through the second upstream region 113. The extension line X1 extends in a manner overlapping the second upstream region 113, though this is to be described later.

As shown in FIG. 2, the second downstream region 114 of the second duct side wall 11b is continuous with the second upstream region 113 on the downstream side of the second upstream region 113. The second downstream region 114 extends in a direction away from the first duct side wall 11a, that is, in a manner approaching the reference line C2 in the width direction of the air duct 11, from the upstream side toward the downstream side in the direction of air flow.

The first upstream region 111 of the first duct side wall 11a is parallel with the second upstream region 113 of the second duct side wall 11b. The first upstream region 111 extends in a manner inclined rightward by an angle θ1 (degrees) with respect to the front-back direction of the passenger compartment CR when the first upstream region 111 is viewed forward from the rear of the passenger compartment CR. That is, the first upstream region 111 is also bent such that the downstream side of the first upstream region 111 is positioned farther from the reference line C2 than the upstream side in the width direction of the air duct 11. The first upstream region 111 may be formed to have a shape different from that of the second upstream region 113.

The first downstream region 112 of the first duct side wall 11a is continuous with the first upstream region 111 on the downstream side of the first upstream region 111. The first downstream region 112 extends in a manner being separated away from the second duct side wall 11b slightly in the width direction of the air duct 11, from the upstream side toward the downstream side in the direction of air flow.

As shown in FIG. 1, the bezel 13 is formed in a rectangular frame shape. Thus, as shown in FIG. 2, the bezel 13 has a rectangular air port 130. The bezel 13 is made of resin. The bezel 13 is configured within the first mounting portion 101 of the instrument panel 100. The bezel 13 may be made of metal or wood. The bezel 13 may also be formed in, for example, an annular shape as long as it has a frame shape.

The bezel 13 is connected to the air duct 11 on the downstream side in the direction of air flow while partially accommodating the air duct 11 therein. More specifically, the bezel 13 has a first bezel side wall 13a and a second bezel side wall 13b. The first bezel side wall 13a is arranged on the left side of the bezel 13 and connected to the first downstream region 112 of the first duct side wall 11a. The second bezel side wall 13b is arranged on the right side of the bezel 13. That is, in comparison between the first bezel side wall 13a and the second bezel side wall 13b, the second bezel side wall 13b is positioned closer to the reference line C2 than the first bezel side wall 13a. The second bezel side wall 13b is connected to the second downstream region 114 of the second duct side wall 11b. The bezel 13 thus faces the second seat 7 while being connected to the air duct 11.

The first fin unit 15 is provided within the air duct 11 and positioned on the downstream side in the direction of air flow relative to the first and second upstream regions 111, 113 of the first duct side wall 11a and the second duct side wall 11b. The first fin unit 15 has multiple first fins 15a to 15e and a connecting member 15f. The first fins 15a to 15e are an example of fins according to an aspect of the disclosure.

The first fins 15a to 15e are arranged in line in the width direction of the air duct 11 with a predetermined space between each other in the order of the first fins 15a to 15e from the first duct side wall 11a. This results in that the first fin 15a is arranged closest to the first duct side wall 11a among the first fins 15a to 15e and the first fin 15e is arranged closest to the second duct side wall 11b among the first fins 15a to 15e. Therefore, the first fin 15e is defined as a specific fin according to an aspect of the disclosure. The first fins 15a to 15e may be designed to be of an appropriate number as long as they are a plurality.

The first fins 15a to 15e have the same shape and are each formed in a plate shape, as shown in FIG. 3. Thus, the first fins 15a to 15e each have an upstream end portion 150 positioned on the upstream side in the direction of air flow and a downstream end portion 151 positioned on the downstream side in the direction of air flow. The first fins 15a to 15e are each connected swingably to the connecting member 15f via a first swing shaft M1 positioned near the upstream end portion 150. Also, the first fins 15a to 15e are each connected swingably to the air duct 11 via a second swing shaft M2 positioned between the upstream end portion 150 and the downstream end portion 151. The first fins 15a to 15e can thus be displaced within the air duct 11 in conjunction with each other by swinging about the first and second swing shafts M1, M2. Specifically, the first fins 15a to 15e are displaceable between a displaced state where the downstream end portions 151 are closest to the second duct side wall 11b as shown in FIGS. 2 and 3 and a displaced state where the downstream end portions 151 are closest to the first duct side wall 11a (not shown).

As shown in FIG. 2, the first fin 15c is provided with an engagement shaft 153. The engagement shaft 153 is positioned near the downstream end portion 151 of the first fin 15c.

As shown in FIG. 3, the first fin unit 15 is here provided within the air duct 11 such that when the first fins 15a to 15e are displaced such that the downstream end portions 151 are closest to the second duct side wall 11b, the upstream end portion 150 of the first fin 15e is positioned on the extension line X1 of the second upstream region 113.

As shown in FIG. 2, the second fin unit 17 is provided within the air port 130 of the bezel 13. The second fin unit 17 is thus positioned on the downstream side in the direction of air flow relative to the first fin unit 15. The second fin unit 17 is swingable vertically within the air port 130.

The second fin unit 17 has multiple second fins 17a and an operating member 17b. The second fins 17a are each formed in a plate shape and extend in the width direction of the second fin unit 17 (in the width direction of the air duct 11 or the lateral direction in FIG. 2). The second fins 17a are arranged in line in the vertical direction of the second fin unit 17. The operating member 17b is provided movably on one of the second fins 17a. The operating member 17b has an engaging portion 170 extending into the air duct 11. The engaging portion 170 is engaged with the engagement shaft 153 of the first fin 15c. This makes it possible to displace the first fin unit 15 and the second fin unit 17 through the operating member 17b. The first register 1 may be configured without the second fin unit 17.

In the thus configured first register 1, air flowing through the air duct 11 flows out through the air port 130 of the bezel 13 toward the second seat 7. At this time, the driver or passenger can operate the operating member 17b to displace the first and second fin units 15, 17, thereby adjusting the direction in which the air flows out through the air port 130. That is, the direction of air outflow can be adjusted laterally by the first fin unit 15 and can be adjusted vertically by the second fin unit 17. Thus, as shown in FIG. 2, when the first fins 15a to 15e of the first fin unit 15 are displaced such that the downstream end portions 151 of the first fins 15a to 15e are closest to the second duct side wall 11b, the air flowing out through the air port 130 flows rightward within the passenger compartment CR toward the reference line C2 of the second seat 7. In the first register 1, it is possible to stably increase the directionality of air flowing toward the reference line C2 of the second seat 7. This operation will hereinafter be described in comparison to a comparative example.

In a register according to a comparative example shown in FIG. 4, the first and second upstream regions 111, 113 extend parallel with the front-back direction of the passenger compartment CR. The other configurations of the register according to the comparative example are the same as those of the first register 1 according to the embodiment. Thus, in the register according to the comparative example, air flows within the air duct 11 from the upstream side toward the downstream side parallel with the front-back direction of the passenger compartment CR. Hence, in the register according to the comparative example, when the first fins 15a to 15e are displaced such that the downstream end portions 151 of the first fins 15a to 15e are closest to the second duct side wall 11b, air contacting each of the first fins 15a to 15e, that is, air guided by each of the first fins 15a to 15e has approximately the same flow rate within the air duct 11. As indicated by the solid arrows in FIG. 4, air guided by each of the first fins 15a to 15d, which are other than the first fin 15e among the first fins 15a to 15e, flows out while being inclined with respect to the air port 130 at an approximately constant angle. In contrast, air guided by the first fin 15e flows between the first fin 15e and the second downstream region 114 of the second duct side wall 11b along the second downstream region 114 to flow out through the air port 130 approximately linearly toward the second seat 7. That is, the direction in which the air guided by each of the first fins 15a to 15d flows out is different from the direction in which the air guided by the first fin 15e flows out. In the register according to the comparative example, this causes the air guided by each of the first fins 15a to 15d and the air guided by the first fin 15e, when flowing out through the air port 130, to collide with each other, resulting in a reduction in the directionality of the air.

In contrast, as shown in FIG. 2, in the first register 1 according to the embodiment, the first upstream region 111 of the first duct side wall 11a and the second upstream region 113 of the second duct side wall 11b are bent such that the downstream side is positioned farther from the reference line C2 than the upstream side in the width direction of the air duct 11. Thus, as indicated by the solid arrows in FIGS. 2 and 3, the first upstream region 111 and the second upstream region 113 cause air flowing within the air duct 11 to flow away leftward from the reference line C2 in the width direction of the air duct 11, from the upstream side toward the downstream side in the flow direction. Thus, when the first fins 15a to 15e are displaced such that the downstream end portions 151 of the first fins 15a to 15e are closest to the second duct side wall 11b, the air flowing within the air duct 11 is less likely to contact the first fin 15e than the first fins 15a to 15d, which are other than the first fin 15e. Particularly, as shown in FIG. 3, in the first register 1, when the first fins 15a to 15e are displaced such that the downstream end portions 151 are closest to the second duct side wall 11b, the upstream end portion 150 of the first fin 15e is positioned on the extension line X1 of the second upstream region 113. This causes the air flowing within the air duct 11 to be more likely to flow on the left side of the first fin 15e so as to be less likely to contact the first fin 15e. Thus, as indicated by the dashed arrow W1 in FIG. 2, it is possible in the first register 1 according to the embodiment to preferably reduce the flow rate of air guided by the first fin 15e to flow between the first fin 15e and the second downstream region 114. This causes the air guided by each of the first fins 15a to 15d and the air guided by the first fin 15e, when flowing out through the air port 130, to be less likely to collide with each other and, even if they may collide with each other, this impact will have only a small effect. In the first register 1 according to the embodiment, it is thus possible to increase the directionality of air flowing toward the reference line C2 of the second seat 7. As a result, the first register 1 according to the embodiment can preferably apply air to the passenger on the second seat 7. The second register 2 shown in FIG. 1 is configured such that it can preferably apply air to the passenger on the second seat 7 as well. Also, like the first register 1, the third and fourth registers 3, 4 can preferably apply air to the passenger on the first seat 5.

The first register 1 according to the embodiment is not required to have a raised portion or the like to make contact with the first fin 15e formed on the second duct side wall 11b in order to increase the directionality of air. This allows the first register 1 according to the embodiment to have an increased flexibility of designing the bezel 13. The same applies to the second to fourth registers 2 to 4.

Also, in the first register 1, the air duct 11 has rigidity making it less likely to be elastically deformed. Hence, in the first register 1, air can flow stably toward the first fin unit 15 due to the shape of the first upstream region 111 of the first duct side wall 11a and the second upstream region 113 of the second duct side wall 11b. The same applies to the second to fourth registers 2 to 4.

The first to fourth registers 1 to 4 according to the embodiment therefore exhibits a high aesthetic appearance and is capable of stably increasing air directionality.

Particularly, in the first register 1, the first upstream region 111 of the first duct side wall 11a extends parallel with the second upstream region 113 of the second duct side wall 11b. Accordingly, the air duct 11 is less likely to have a complex shape and thereby can be formed easily. The first upstream region 111 and the second upstream region 113 also cause air flowing within the air duct 11 to preferably flow away leftward from the reference line C2 in the width direction of the air duct 11, from the upstream side toward the downstream side in the flow direction. The same applies to the second to fourth registers 2 to 4.

Also, in the first register 1, the first fins 15a to 15e are formed to have the same shape. The first fins 15a to 15e and therefore the first register 1 can accordingly be manufactured easily at reduced manufacturing costs. The same applies to the second to fourth registers 2 to 4.

While the aspects of the disclosure have heretofore been described according to the embodiment, it will be appreciated that the disclosure is not intended to be limited to the embodiment above, but may be applied with appropriate modifications without departing from the spirit thereof. The above-described embodiment and the following modifications may also be practiced in combination with each other as long as the such combination has no technical inconsistency.

For example, the first to fourth registers 1 to 4 may be arranged at positions further to the rear than the first and second seats 5, 7 within the passenger compartment CR to define a seat arranged at a position further to the rear than the first and second seats 5, 7 as a specific seat.

The first duct side wall 11a may also be formed only by the first upstream region 111. Similarly, the second duct side wall 11b may be formed only by the second upstream region 113.

### INDUSTRIAL APPLICABILITY

The register according to an aspect of the disclosure is applicable to an air-conditioner in a transport vehicle such as a passenger vehicle or a bus.

1. A register configured to be provided within a passenger compartment in which a plurality of seats are disposed, the register facing a specific seat selected from the seats and being configured to feed air to the specific seat, wherein an imaginary reference line is defined that extends in a front-back direction of the specific seat through a center in a width direction of the specific seat, the register comprising:
a tubular air duct having rigidity and configured such that air flows inside in a flow direction from an upstream side toward a downstream side;
a bezel formed in a frame shape and connected to the air duct on the downstream side of the air duct to face the specific seat; and
a plurality of fins each formed in a plate shape and provided in a displaceable manner within the air duct, the fins being configured so as to guide air within the air duct thereby adjusting a direction in which the air flows out through the bezel, wherein
the bezel has a first bezel side wall and a second bezel side wall opposed to the first bezel side wall, wherein in comparison between the first bezel side wall and the second bezel side wall, the second bezel side wall is positioned closer to the reference line than the first bezel side wall,
the air duct has a first duct side wall extending in the flow direction to be connected to the first bezel side wall and a second duct side wall extending in the flow direction to be connected to the second bezel side wall,
the fins are configured between the first duct side wall and the second duct side wall with a predetermined space between each other in the width direction, and
the second duct side wall is bent such that a downstream side of the second duct side wall is positioned farther in the width direction from the reference line than an upstream side of the second duct side wall.

2. The register according to claim 1, wherein the first duct side wall extends parallel with the second duct side wall.

3. The register according to claim 1, wherein
the fins each have an upstream end portion positioned on the upstream side and a downstream end portion positioned on the downstream side,
an imaginary extension line is defined to extend through the second duct side wall,
one of the fins that is closest to the second duct side wall is defined as a specific fin, and
when the fins are displaced such that the downstream end portions are closest to the second duct side wall, the upstream end portion of the specific fin is positioned on the extension line.

4. The register according to claim 1, wherein the fins have a same shape.

5. A method of manufacturing a register, the register being provided within a passenger compartment in which a plurality of seats are disposed, the register facing a specific seat selected from the seats and being configured to feed air to the specific seat, wherein an imaginary reference line is defined that extends in a front-back direction of the specific seat through a center in a width direction of the specific seat,
the manufacturing method comprising:
preparing a tubular air duct having rigidity inside of which air flows in a flow direction from an upstream side toward a downstream side;
connecting a bezel formed in a frame shape to the air duct on the downstream side of the air duct to face the specific seat;
providing a plurality of fins each formed in a plate shape within the air duct in a displaceable manner, the fins being provided within the air duct such that the fins guide air within the air duct to adjust a direction in which the air flows out through the bezel;
in comparison between a first bezel side wall of the bezel and a second bezel side wall opposed to the first bezel side wall, arranging the second bezel side wall closer to the reference line than the first bezel side wall;
extending a first duct side wall of the air duct in the flow direction to be connected to the first bezel side wall;
extending a second duct side wall of the air duct in the flow direction to be connected to the second bezel side wall;
arranging the fins between the first duct side wall and the second duct side wall so as to be provided with a predetermined space between each other in the width direction; and
bending the second duct side wall such that a downstream side of the second duct side wall is positioned farther in the width direction from the reference line than an upstream side of the second duct side wall.
